(19) United States
(12) Patent Application Publication
(10) Pub. No.: US 2016/0186839 A1
(43) Pub. Date: Jun. 30, 2016

(54) TENSIONER WITH AXIAL SEAL

(71) Applicant: THE GATES CORPORATION, DENVER, CO (US)

(72) Inventor: Michael Adams, Aachen (DE)

(21) Appl. No.: 14/583,318

(22) Filed: Dec. 26, 2014

(51) Int. Cl. F16H 7/12; F16J 15/32

(52) U.S. Cl. CPC F16H 7/12; F16J 15/3288; F16J 15/3292; F16H 2007/0842

(57) ABSTRACT

A tensioner having an axial seal comprising a base having a receiving portion, the receiving portion extending about a circumference of the base, a pivot arm pivotally engaged with the base, the receiving portion in continuous proximity to the pivot arm, a spring urging a movement of the pivot arm, and an axial seal engaged with the receiving portion, the axial seal comprising members extending in an axial direction (A-A), the members in sliding contact with a pivot arm surface.

### FIELD OF THE INVENTION

The invention relates to a tensioner axial seal, and more particularly, to a tensioner having an axial seal engaged with the receiving portion, the axial seal comprising members extending in an axial direction (A-A), the members in sliding contact with a pivot arm surface.

### BACKGROUND OF THE INVENTION

Labyrinth seals are an established technology for tensioners. However, such seals do not comprise flexible members and therefore can be severely limited in their ability to prevent infiltration of debris into a tensioner body. This can lead to premature wear and failure.

Brush seals are well established in turbomachinery. They are used in power turbines to prevent debris entry and to provide a pressure barrier to reduce steam and seal air leakage.

Representative of the art is U.S. Pat. No. 8,777,563 which discloses a brush seal assembly for turbomachinery having a rotor can include a stationary seal component, a floating seal component coupled to the stationary seal component and circumferentially angled bristles arranged in a bristle pack, disposed in the floating seal component and extended axially with respect to the rotor.

What is needed is a tensioner having an axial seal engaged with the receiving portion, the axial seal comprising members extending in an axial direction (A-A), the members in sliding contact with a pivot arm surface. The present invention meets this need.

### SUMMARY OF THE INVENTION

The primary aspect of the invention is to provide a tensioner having an axial seal engaged with the receiving portion, the axial seal comprising members extending in an axial direction (A-A), the members in sliding contact with a pivot arm surface.

Other aspects of the invention will be pointed out or made obvious by the following description of the invention and the accompanying drawings.

The invention comprises a tensioner having an axial seal comprising a base having a receiving portion, the receiving portion extending about a circumference of the base, a pivot arm pivotally engaged with the base, the receiving portion in continuous proximity to the pivot arm, a spring urging a movement of the pivot arm, and an axial seal engaged with the receiving portion, the axial seal comprising members extending in an axial direction (A-A), the members in sliding contact with a pivot arm surface.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective cross-section of a prior art tensioner.

FIG. 2 is a cross-section elevation view of the prior art tensioner in FIG. 1.

FIG. 3 is a cross-section elevation view of the inventive seal arrangement.

FIG. 4 is a perspective view of the brush seal.

FIG. 5 is a perspective view of an alternate brush seal.

### DETAILED DESCRIPTION OF THE PREFERRED EMBODIMENT

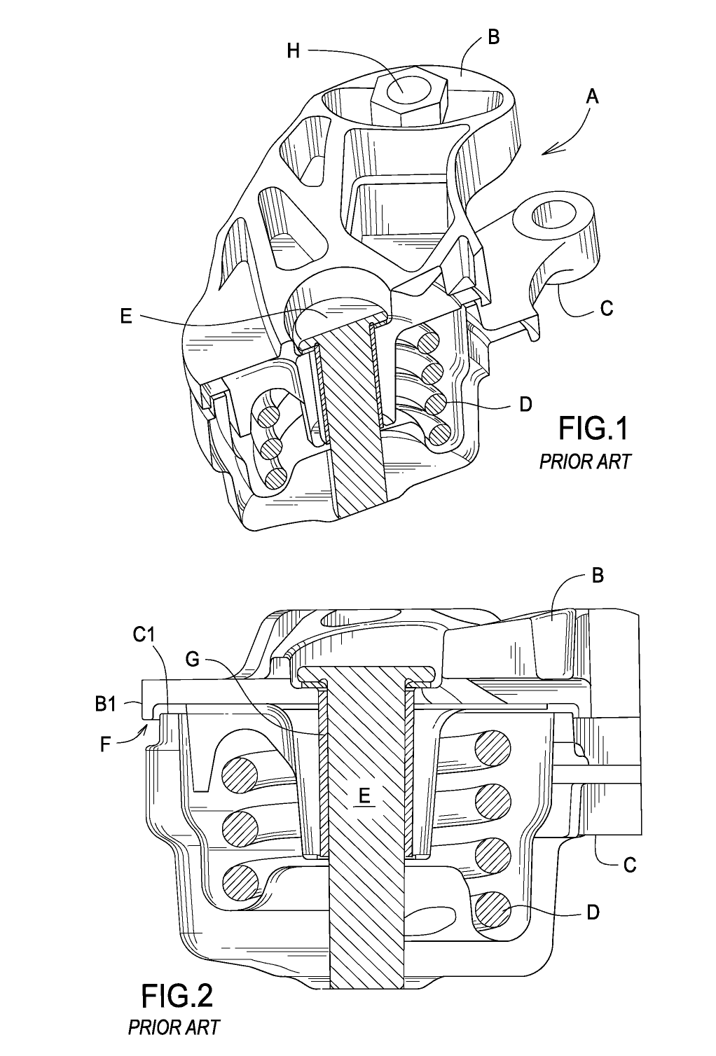

FIG. 1 is a perspective cross-section of a prior art tensioner. Tensioner A comprises a pivot arm B and base C. Pivot arm B pivots about shaft E. Shaft E is typically press fit into base C. Spring D urges pivot arm B into a belt (not shown), thereby applying a preload.

FIG. 2 is a cross-section elevation view of the prior art tensioner in FIG. 1. The tensioner in FIG. 1 comprises a labyrinth seal F. Seal F is formed by pivot arm portion B1 overhanging base portion C1. The relationship forms the seal tortious path. Labyrinth seal F is intended to prevent debris from entering the tensioner which can lead to failure of various components including bush G.

In a typical installation a pulley (not shown) is journalled to the pivot arm at threaded portion H.

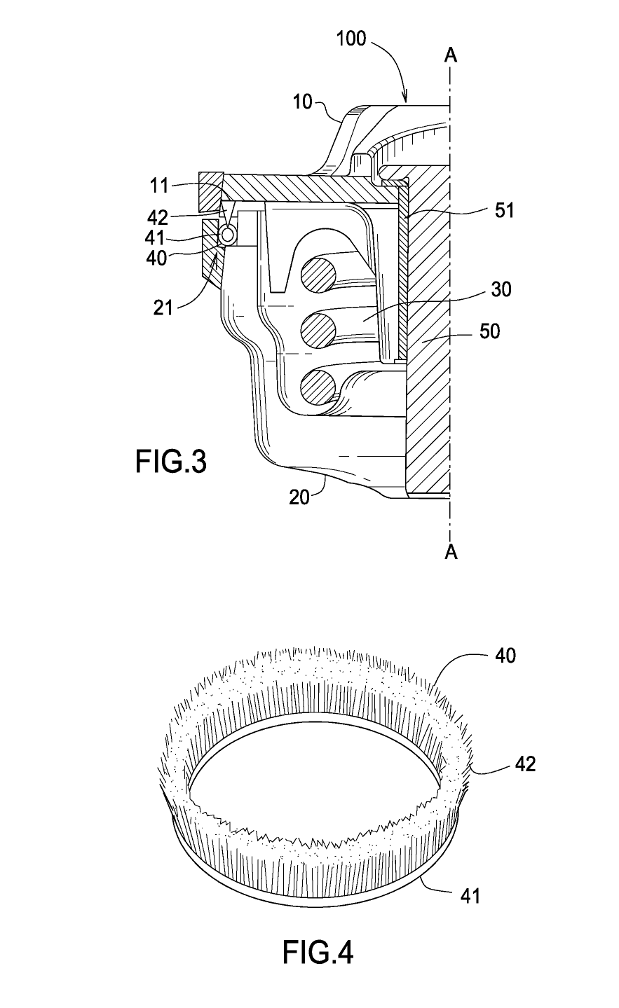

FIG. 3 is a cross-section elevation view of the inventive seal arrangement. Tensioner 100 comprises a pivot arm 10 journalled or pivotally engaged with shaft 50. Shaft 50 is press fit into base 20. Pivot arm 10 pivots on a low friction bush 51.

Brush seal 40 is mounted to base 20 in receiving portion 21. Receiving portion 21 is disposed about an outer circumference of base 20. The receiving portion is configured to be in continuous proximity to the pivot arm 10.

Brush seal 40 is circular and comprises a flexible base portion 41. Bristles 42 extend in an axial direction from circular base portion 41. Bristles 42 are flexible to accommodate variations in the form of the pivot arm surface. The axial direction is parallel to the axis of rotation of the pivot arm A-A.

Bristles 42 are in sliding contact with surface 11 of pivot arm 10, thereby forming a seal about the entire perimeter of the base.

FIG. 4 is a perspective view of the brush seal. Bristles 42 extend in an axial direction parallel to axis A-A. Base portion 41 can comprise any suitable flexible material in order to allow the seal 40 to conform to receiving portion 21. The brush seal provides sealing against debris while allowing free pivotal movement of the pivot arm 10. An advantage of the brush seal is that it does not require any lubricant or lubricious qualities to operate.

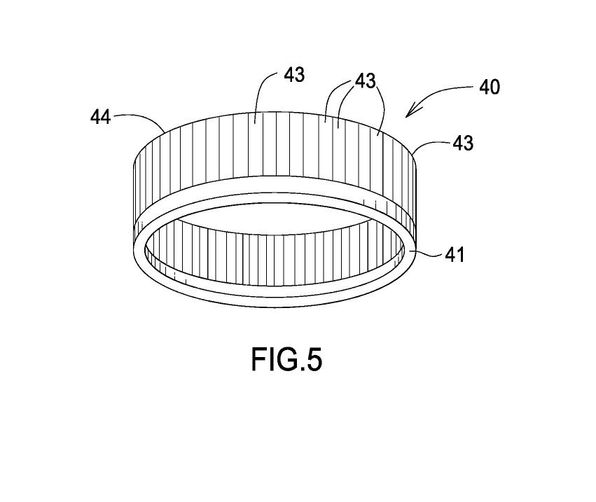

FIG. 5 is a perspective view of an alternate brush seal. In an alternate embodiment bristles 42 are replaced with a plurality of flexible members 43 which form a barrier to debris entry. Flexible members 43 comprise a planar form and are disposed adjacent to one another about the circumference of brush seal 40. Members 43 extend in an axial direction from the base portion 41. An end 44 of each member 43 slidingly engages surface 11.

In yet another alternate embodiment members 43 or bristles 42 extend in a radial direction either inward or outward from an axis of rotation A-A. The radial direction is normal to the axial direction.

Although forms of the invention have been described herein, it will be obvious to those skilled in the art that variations may be made in the construction and relation of parts and method without departing from the spirit and scope of the inventions described herein.

I claim:

1. A tensioner having an axial seal comprising:
a base having a receiving portion, the receiving portion extending about a circumference of the base;
a pivot arm pivotally engaged with the base, the receiving portion in continuous proximity to the pivot arm;
a spring urging a movement of the pivot arm; and
an axial seal engaged with the receiving portion, the axial seal comprising members extending in an axial direction (A-A), the members in sliding contact with a pivot arm surface.

2. The tensioner having an axial seal as in claim 1, wherein the members comprise flexible bristles.

3. The tensioner having an axial seal as in claim 1, wherein the members comprise flexible planar members.

4. The tensioner having an axial seal as in claim 1, wherein the base comprises a shaft, the pivot arm journalled to the shaft.

5. A tensioner having an axial seal comprising:
a base having a receiving portion, the receiving portion extending about a circumference of the base;
a shaft mounted to the base;
a pivot arm journalled to the shaft, the receiving portion in continuous proximity to the pivot arm;
a spring urging a movement of the pivot arm; and
a seal engaged with the receiving portion, the seal comprising flexible members extending in an axial direction (A-A), the members in sliding contact with a pivot arm surface.

6. A tensioner having an axial seal comprising:
a base having a receiving portion, the receiving portion extending about a base circumference;
a shaft mounted to the base;
a pivot arm journalled to the shaft;
the receiving portion disposed in continuous proximity to the pivot arm;
a spring urging a movement of the pivot arm; and
a circular seal engaged with the receiving portion, the circular seal comprising flexible planar members extending in an axial direction (A-A), the members in sliding contact with a pivot arm surface.
